(19) United States
(12) Patent Application Publication
(10) Pub. No.: US 2023/0181427 A1
(43) Pub. Date: Jun. 15, 2023

(54) FLOW CONTROL SYSTEM FOR A BABY BOTTLE

(71) Applicant: Preemie-Pacer, LLC, O'Fallon, MO (US)

(72) Inventors: Roberta Pineda, St. Louis, MO (US); Jeffrey Macler, Tecumseh, MO (US)

(21) Appl. No.: 17/549,798

(22) Filed: Dec. 13, 2021

(51) Int. Cl. A61J 11/00; A61J 9/00

(52) U.S. Cl. CPC A61J 11/002; A61J 9/00

(57) ABSTRACT

A baby bottle, a flow control for a baby bottle, a baby bottle, including a flow control system, and a method of feeding an infant that serves to pace the infant's feeding rhythm. Generally, these devices and methods will be of use for a preterm infant who lacks coordination of the suck-swallow-breathe synchrony, but can also be used with full term infants who can benefit from control of the flow of milk from a bottle, this includes, but is not limited to, infants with gastroesophageal reflux who can require pacing of feeds to allow for gastric emptying. The device generally regulates the flow of the fluid from the bottle as desired by the feeder. The device also serves to consistently slow the flow of milk during oral feeding.

### BACKGROUND

### 1. Field of the Invention

This disclosure is related to the field of devices and methods for providing intermittent flow in a vessel, particularly intermittent flow in a baby bottle to assist in getting preterm infants to successfully eat.

### 2. Description of the Related Art

The average gestation period of a human being is generally considered to be 280 days, or around 40 weeks. Recent science has indicated that birth, without any medical intervention or complications of preterm birth, will, on average, occur at a little over 38 weeks after fertilization. Generally, an infant born from 37-42 weeks after conception is considered to be “full term.” A large number of babies, however, are born prior to this period. In the United States, around 12% of babies born each year are considered to be “preterm,” that is, before the 37th week. Some of these births occur spontaneously, some occur due to complications in pregnancy, others are scheduled early due to the need for planned Cesarean section births, some are due induced labor following abnormal lab results, and others from concern that an infant is getting too large to be easily delivered.

Regardless of the reason that an infant is born preterm, preterm infants (and even those born in the 38th and 39th week compared to those born later) generally have more medical issues at birth than full term infants. For example, infant mortality rates for preterm infants are generally double those of full term infants. Another problem associated with preterm babies is that they have trouble learning how to eat and eating. The act of nursing (or alternatively eating from a bottle) generally requires an infant to follow a pattern usually referred to as “suck-swallow-breathe.”in this pattern, an infant sucks once, swallows once, breathes once, and then repeats. Preterm infants, however, may feed with repetitions of 3 or 4 (or more) sucks and swallows and 1 breathing break. However, many preterm infants have trouble maintaining any pattern, and an inability to feed can lead to further complications with the infant. For example, this can result in increased medical expense due to the need to keep the infant at a hospital.

Because many preterm infants (and particularly very early preterm infants) are maintained in a Neonatal Intensive Care Unit (NICU), they are often bottle fed (breastfeeding is a challenge) and effective feeding patterns must be imposed until the infant's central nervous system matures to enable coordination of the suck-swallow-breathe pattern. While preterm infants often demonstrate adequate suction and compression on the bottle to express milk very early in gestation, the infant's immature central nervous system does not signal the infant to pause for respiration, which results in inadequate oxygen in the blood and dangerous drops in heart rate.

In the months prior to term equivalent age, cautious caregivers can promote an imposed breathing break by allowing the infant to take a few sucks from the bottle followed by pulling the bottle out of the infant's mouth. This procedure requires special expertise and considerable time; causes the infant significant energy expenditure and physiological stress; and disrupts the feeding process. The complexities of feeding infants delay discharge and increase hospital costs. NICU nurses and therapists currently manually pace preterm infants during bottle feeding, and parents are often taught how to pace preterm infants during oral feeds. It has been found that many preterm infants will continue sucking until prompted to swallow and breathe by the feeder.

During feeding, monitors attached to the infants in the NICU collect data regarding respiration, heart rate, and other vital signs to assist the nurse in knowing when to prompt the infant to swallow and breathe. However, these monitors often take longer to alert a nurse than desired, Thus, feeding of infants that lack successful suck-swallow-breathe coordination typically requires the nurse to analyze the infant's facial features for sips of stress, such as raised eyebrows, breathing difficulty, or blue discoloration. In effect, the need to pause feeding is mostly dependent on the feeder's skill and experience in feeding such infants. This can make it exceedingly problematic for feeding to be carried out by parents, or other non-specialized personnel, as they simply lack the experience of feeding to know how to correctly recognize signs of distress quickly.

When the NICU nurse detects that the infant needs to breathe, the nurse typically tilts or, if necessary, completely removes the bottle to stop the flow of liquid from the bottle. There are a number of different processes, but each effectively recognizes that the need to halt the flow of fluid needs be paired with a need to not overly disrupt the act of feeding and, particularly, being correctly latched to the bottle. The lack of milk typically cues the infant to swallow and begin breathing again. If done correctly, once a breath is taken, the bottle can be returned to the normal feeding position and the infant will commence sucking again. This system is highly subjective to human intervention, however, and requires constant attention during feeding to minimize the possibility of risks such as choking or aspiration. Further, it requires a considerable amount of skill to halt fluid flow from the bottle while not overly interrupting the feeding cycle to the point where it may be difficult to get the infant to resume. This is also all balanced within time constraints for the amount of time the feeding may take to allow nurses and other skilled staff to meet the needs of all the patients in a NICU.

Many infants will also eventually pick up the rhythm of suck-swallow-breathe after only a few repetitions of a forced-pace system, and it is desirable for infants that quickly pick up the pattern to begin pacing naturally without a forced-pace being imposed. This allows them to maintain their own pattern and maintain their own pace while both maximizing the amount of intake and allowing necessary connections in how to feed to be made. Removing or even maneuvering the bottle to cease fluid flow is necessarily disruptive to feeding behavior and can cause problems with the infant establishing a pattern, gaining an adequate swallow on fluid that has been expressed, and/or re-establishing the feeding response.

### SUMMARY

The following is a summary of the invention that should provide, to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, it is desirable to provide a feeding device that eliminates the need to constantly monitor a feeding in a preterm infant and manually alter the flow of liquid in a bottle.

There is described herein, among other things, an embodiment of a baby bottle for controlling the flow of a feeding fluid, the bottle comprising: a main body; a tube in fluid communication with the main body and having a hollow, volume and two opposing ends; a nipple in fluid communication with the tube; and a pinch mechanism including a plunger for obstructing flow of fluid through the tube; wherein the pinch mechanism is configured to obstruct flow of fluid through the tube in a closed state; and wherein the pinch mechanism is configured to not obstruct flow of fluid through the tube in an open state.

In an embodiment of the bottle, the tube extends from the tip of the nipple to the main body.

In an embodiment of the bottle, the main body is a rigid bottle.

In an embodiment of the bottle, the infant is a preterm infant.

In an embodiment, the bottle thriller comprises a feeding reservoir formed in the nipple, and wherein the tube extends from the feeding reservoir to the main body.

In an embodiment, the bottle further comprises a control system for controlling the pinch mechanism and a motor, and wherein the control mechanism instructs the motor to alter the positioning of the plunger of the pinch mechanism.

In an embodiment of the bottle, the tube extends from the tip of the nipple to the main body.

In an embodiment of the bottle, the main body is a rigid bottle.

In an embodiment of the bottle, the infant is a preterm infant.

In an embodiment, the bottle further comprises a feeding reservoir formed in the nipple, and wherein the tube extends from the feeding reservoir to the main body.

There is also described herein, in an embodiment, a baby bottle, for controlling the flow of a feeding fluid, the bottle comprising: a main body; a tube in fluid communication with the main body and having a hollow volume and two opposing ends; a nipple in fluid communication with the tube; and an cutoff mechanism positioned proximate to the tube; wherein the cutoff mechanism is configured to obstruct flow of fluid through the tube in a closed state: wherein the cutoff mechanism is configured to not obstruct flow of fluid through the tube in an open state; and wherein the cutoff mechanism is biased toward the open state and will move to the closed state only upon action of a user of the baby bottle.

In an embodiment of the bottle, the tube extends from the tip of the nipple to the main body.

In an embodiment of the bottle, the main body is a rigid bottle.

In an embodiment of the bottle, the infant is a preterm infant.

In an embodiment, the bottle further comprises a feeding reservoir formed in the nipple, and wherein the tube extends from the feeding reservoir to the main body.

There is also described herein, in an embodiment, a baby bottle for controlling the flow of a feeding fluid, the bottle comprising: a main body; a tube in fluid communication with the main body and having a hollow volume and two opposing ends; a nipple in fluid communication with the tube; and a cutoff mechanism positioned proximate to the tube, wherein the cutoff mechanism is configured to obstruct flow of fluid through the tube in a closed state; wherein the cutoff mechanism is configured to not obstruct flow of fluid through the tube in an open state; and wherein the cutoff mechanism is biased toward the closed state and will move to the open state only upon action of a user of the baby bottle.

In an embodiment of the bottle, the tube extends from the tip of the nipple to the main body.

In an embodiment of the bottle, the main body is a rigid bottle.

In an embodiment of the bottle, the infant is a preterm infant.

In an embodiment, the bottle further comprises a feeding reservoir formed in the nipple, and wherein the tube extends from the feeding reservoir to the main body.

### BRIEF DESCRIPTION OF THE DRAWINGS

FIGS. 1A, 1B, and IC provide an exploded view, assembly side view, and perspective view, respectively, of an embodiment of an infant bottle that may be used with an embodiment of a flow control system disclosed herein.

FIG. 2 provides a top, side perspective view of a first embodiment of an infant bottle in accordance with this disclosure.

FIG. 3 provides a side cross-sectional exploded view of the embodiment of an infant bottle shown in FIG. 2.

FIG. 4 provides a top, side perspective view of a second embodiment of an infant bottle in accordance with this disclosure.

FIG. 5 provides a side cross-sectional exploded view of the embodiment of an infant bottle shown in FIG. 4.

FIG. 6 provides a top, side perspective view of a third embodiment of an infant bottle in accordance with this disclosure.

FIG. 7 provides a side cross-sectional exploded view of the embodiment of an infant bottle shown in FIG. 6.

FIG. 8 provides a close up top, side perspective view of the embodiment of an iris mechanism of the embodiment of an infant bottle shown in FIG. 6.

### DESCRIPTION OF THE PREFERRED EMBODIMENT(S)

The following detailed description and disclosure illustrates by way of example and not by way of limitation. This description will clearly enable one skilled in the art to make and use the disclosed systems and apparatus, and describes several embodiments, adaptations, variations, alternatives, and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

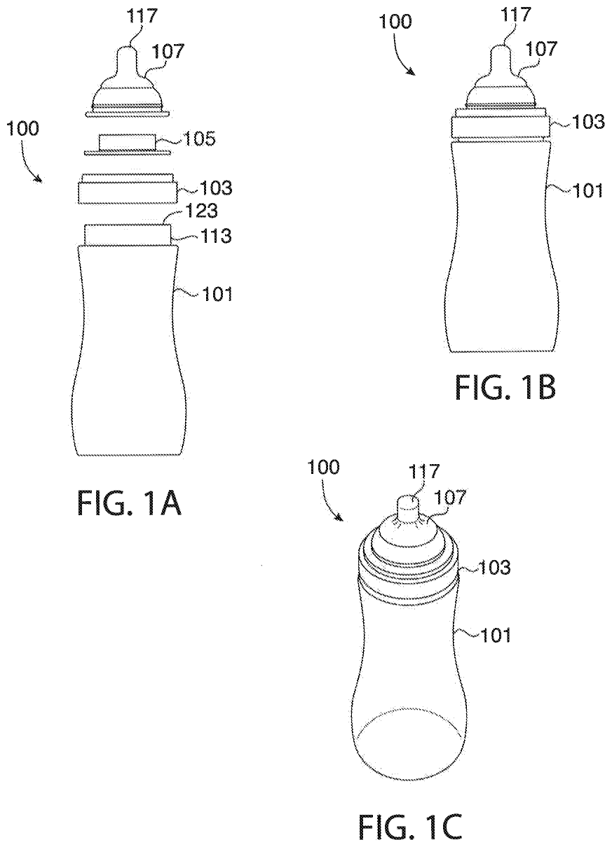

A normal NICU feeding bottle that may contain about 30-90 milliliters of feeding solution in a generally cylindrical bottle (100) as shown in FIG. 1. While there is some variation among baby bottles, those used in any particular NICU are generally of a particular type and most are broadly similar. It is preferable that the feeding control be provided without needing to fundamentally alter the infant bottle (100) or having to provide a specialized bottle at least because that allows NICU nurses to utilize a particular baby bottle for all infants, which can be desirable. Further, while the device is primarily for use by medical personnel, parents can be present and may need to continue the same feeding pattern at home. Thus, a feeding device needs to be simple to use; replicate its function regardless of the user; be dependable to minimize a chance of failure or further frustration for the infant; and be usable and effective for a variety of ranges of strength and feeding styles of preterm infants.

Further, because of its use in both a hospital and home setting, while in an embodiment the device may be disposable and single use, the device can preferably be provided sterile, be re-sterilizable, and is ideally easily washable, preferably in a standard dishwasher.

FIG. 1 provides an embodiment of an infant bottle (100) that may be used with a flow control system to provide for intermittent flow. This may be used by and with a preterm infant, with any high-risk or other infant displaying feeding problems, or even with an infant without increased risk or feeding problems but where feeding pacing is desirable. The bottle (100) is of standard design and comprises a main body (101), which is used to house milk, formula, or another liquid product for feeding the infant, a nipple (107) upon which the infant sucks in order to pull fluid from the main body, and a connecting ring (103) which serves to hold the nipple (107) in place on the bottle (100). In a traditional operation, the main body (101) is filled with fluid, the nipple (107) is seated inside the connecting ring (103), and the connecting ring is screwed onto a mating screw ring (113) on the main body (101). The bottle (100) may then be inverted (placing the nipple (107) below the main body (101)). Fluid flows from the main body (101) into the nipple and may be held in place inside the nipple (107), or may begin to flow, depending on the construction of the infant bottle (100).

The nipple will generally include at least one hole at its distal end (117) through which the fluid can pass. For very young infants, the hole is usually sufficiently small that the surface tension of the fluid will not allow it to pass through without pressure being applied. An infant is fed by placing the nipple (107) in their mouth. They will generally instinctually suck on the nipple (107) pulling the fluid through the hole and into their mouth. For an infant that has suck-swallow-breathe activity, once the infant has sufficient fluid in their mouth, they will cease sucking on the nipple (107) and swallow. They will then breathe, which may relax the pressure generated in the nipple (107).

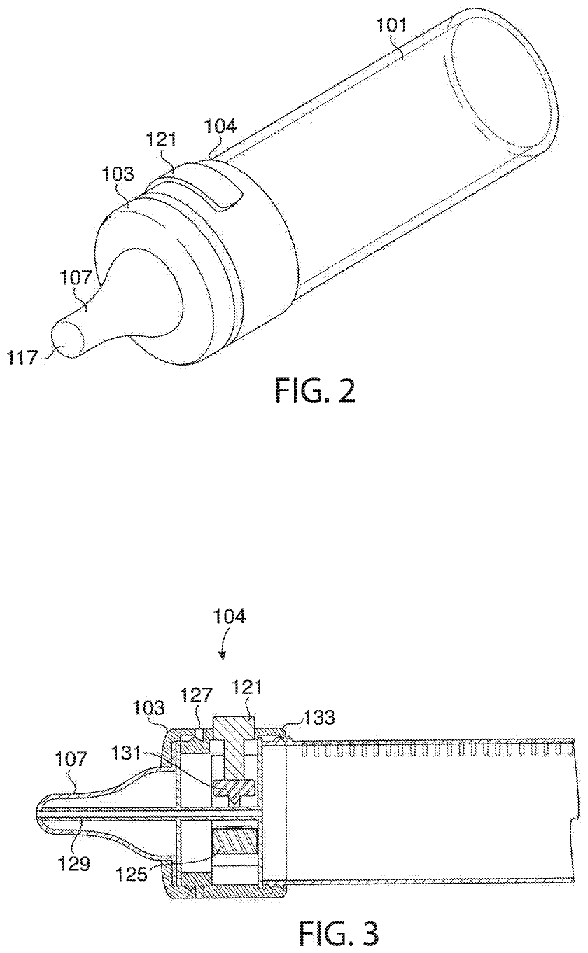

In the embodiment of FIG. 2, in order to assist with the suck-swallow-breathe activity, there is a manually operated flow controlling system between the nipple (107) and the main body (101). Specifically, in the embodiment shown in FIG. 2, the infant bottle (100) includes a cutoff mechanism (104) that includes a connecting ring (103) and a button (121), which button (121) may be used by someone feeding an infant to modulate the supply of milk being delivered to the infant. Specifically, the cutoff mechanism (104) may be designed so that flow of milk through the nipple (107) may be regulated by pressing and releasing the button (121). As seen in FIGS. 2 and 3, the cutoff mechanism (104) may also be designed to seat behind and partially within the structure of the nipple (107) and will generally be held in place by the connecting ring (103) and the main body (101).

The cutoff mechanism (104) of the embodiment of an infant bottle (100) shown in FIGS. 2 and 3 comprises four major components: a cutoff body (133), a connecting ring (103), a pinch mechanism (131), and a tube (129). The cutoff body (133) houses many of the components of the cutoff mechanism (104) and serves as a main structure and base for all of the components of the cutoff mechanism (104). The pinch mechanism (104) typically also includes the button (121), formed as a piece of the greater whole. The connecting ring (103) serves to connect the cutoff mechanism (104) to the main body (101), along with the nipple (107). As is true in other embodiments, these various parts may be made from any material and may have any construction. Typically, the component other than the nipple (107) will be made from a material that provides sufficient rigidity and protection from the environment such that the cutoff mechanism (104) may be securely attached to the main body (101) while the interior of the infant bottle (100) is shielded from external influences or contaminants. As can be seen in FIG. 1, the cutoff body (133) and connecting ring (103) may be designed to fit with the nipple (107) and main body (101) of a standard NICU, or any other, baby bottle (100).

Also included in and around the cutoff mechanism (104) is a tube (129) and a pinch mechanism (131). The tube (129) may be removable from the cutoff mechanism (104) and may attached to the nipple (107), but it may be co-formed as a part of the nipple (107) or as part of a separate sub-chamber for holding milk (not depicted in the figures) within the main body (101). The pinch mechanism (131) may then be brought into close proximity to the tube (129). In this way, the pinch mechanism (131) may pinch, or impede the flow of material through, the tube (129) by moving forward in the direction of the tube (129).

The tube (129) typically extends though the nipple (107) from within the cutoff body (133) and may extend into the main body (101). In the embodiment depicted in FIGS. 2 and 3, the tube (129) is positioned so as to be in contact with the end of the nipple (107) and will generally be positioned so as to place its hollow internal volume in contact with a hole (117) located at the end of the nipple (107), as is common in nipples today. This insulates the hollow internal volume of the tube (129) from the environment around the infant bottle (100).

Depending on the embodiment, the tube (129) may be co-formed with the nipple (107) so as to provide for the positioning discussed above, or it may be manufactured separately. In an embodiment, the nipple (107) may include a positioning guide or mount that allows for the tube (129) to be reliably positioned. For example, the forward end of the tube (129) may act as a male connector with a molded mating female connector being positioned on the inside of the tip of the nipple (107). Alternatively, the tube (129) may simply be positioned in the depicted arrangement because that is the most likely position given the shape of the nipple (107) and tube (129). This arrangement may work particularly well if the outer diameter of the tube (129) is generally similar to the inner diameter of the tip/teat portion of the nipple (107). In a still further alternative embodiment, the tube (129) does not need to be positioned directly adjacent to the hole (117), but there may be positioned within the nipple (107) a void that is formed by a barrier (not shown in figures), which void may even comprise the entire internal volume, of the nipple (107) and which may be in contact with the hole (117) and the tube (129).

Regardless of how the tube (129) is connected to the hole (117), their will generally be considered a fluid reservoir created by the arrangement. Specifically, the reservoir is the fluid that is within the portion of the internal volume of the tube (129) forward of the pinch mechanism (131), along with any void located prior the hole (117). For ease of reference, and regardless of embodiment or volume, this volume is referred to as the feeding reservoir herein. In the depicted embodiment of FIGS. 2 and 3, the feeding reservoir has essentially the same volume as the portion of the internal volume of the tube (129) forward, of the pinch mechanism (131) because there is no void depicted. However, if a barrier was present and the tube (129) was retracted slightly so as to create a gap between the end of the tube (129) and the end of the nipple (107) allowing fluid flow between them, the feeding reservoir would comprise the combined volume of the portion of the internal volume of the tube (129) forward of the pinch mechanism (131) and the void within the nipple (107).

Regardless of the manner of positioning of the tube (129) to form the feeding reservoir, the tube (129) will generally extend from the main body (101) through the cutoff mechanism (104) and into the nipple (107). Generally, the tube (129) will be constructed of medical silicone or a similar material, and, in an embodiment, the material used is similar to the material of which the nipple (107) is formed. In order to position the tube (129), the tube (129) will generally be placed first inside the nipple (107) through its open back end and then simply pushed up into contact with the tip of the nipple (107). Alternatively, the tube (129) may be threaded through the tip of the nipple (107). In this latter embodiment, the hole (117) will generally simply be the end of the hollow interior of the tube (129) as opposed to their being a separate hole (117) formed by the nipple (107). The tube (129) may be considered to be “thick walled” in many embodiments and may have a wall thickness greater than or equal to the diameter of the internal volume of the tube (129).

It should be recognized that FIGS. 2 and 3 provide only a single embodiment of a bottle (100) and the arrangement and assembly of components. In an alternative embodiment, any of the components may be formed integrally or in separate parts. For example, in some embodiments, milk will be held in the main body (100, while in others, milk may be held in a sub-chamber (not depicted in the figures) of the main body (101). Such a sub-chamber may be integrally formed with the main body (101); may be a separate part; may be a disposable part like a big; or any other system that will hold fluids.

Further, in some embodiments, the nipple (107) and the tube (129) may be formed as a single, integrated unit. In another example of a still further embodiment, the tube (129) may be positioned first (or may be formed or provided as a part of the bottle (100) or the sub-chamber (not depicted in the figures)), and any combination of the formations may be in the form of a cartridge that slides into the rear of the bottle (100). Alternatively, the tube (129) may terminate at a needle and the sub-chamber may be in the form of a medication bottle designed for use with a syringe which has a rubber (or other) sealing surface designed to be penetrated by a needle to create a fluid pathway. Depending on embodiment, other forms of connection that allow for the feeding fluid into the tube (129) from the main body (101) or a sub-chamber are also possible. The only requirement is that the tube (129) is able to feed the receive fluids, and that a user or the system itself may regulate the flow of fluid through the tube (129).

In some embodiments, the main body (101), tube (129), and nipple (107) may be designed to be disposable after a single use. In some embodiments, any of the components of the infant bottle (100) may be reusable between multiple infant's and multiple feedings, potentially with minimal cleaning and/or sterilization. In some embodiments, the whole infant bottle (100) may be disposable, or may be entirely cleaned and sanitized between uses.

In a first mode of operation, the pinch mechanism (131) defaults to a closed (or pinched) state when the button (121) is not being depressed. Typically, the pinch mechanism in this embodiment will be biased to the closed state by some sort of force, such as the force of a compressed spring system or other deformed. In other embodiments, any source of biasing force may be used, as would be understood by persons of ordinary skill in the art. In this embodiment, a closed state indicates that fluid will not, flow through the tube (129). In the embodiment depicted in FIG. 3, the pinch mechanism (131) includes a narrowed pinching portion proximate to the tube (129). In the closed state, this narrowed pinching portion will contact and pinch the tube (129), or otherwise obstruct the tube (129). In some embodiments, more than a single narrowed pinching portion may be used to create the obstruction, and such a portion may have any shape and design. On the other hand, in the open state, the pinch mechanism (131) is brought away from the tube (129), such that no obstruction is formed and fluid may flow though the tube (129). In other embodiments, the pinch mechanism (131) may have any construction and design so long that the pinch mechanism (131) may be modulated by the user and that such modulation will, in turn, modulate the flow of fluid from the nipple (107). In other embodiments, the pinch mechanism (131) may default to an open (or not pinched) state when the button (121) is not being depressed.

When using an embodiment of an infant bottle (100) having a pinch mechanism (131) that defaults to a closed stated, a feeder (person who is conducting a feeding for an infant) would typically fill the main body (101), or sub-chamber or other fluid holding system, with a fluid for feeding an infant. Specifically, the main body (101) or a sub-chamber will generally be filled with either previously expressed milk, with prepared formula, or with some combination. Other fluids may also be provided in particular cases, such as to provide oral medication. In embodiments that use a sub-chamber, the sub-chamber may be filled separately and subsequently sealed with a cap, such as a single use locking cap. Such a single use locking cap can be, but is not limited to, one which is irrevocably damaged when it is removed or used, such as those traditionally used for food which have a breaking locking ring or those that include a breakaway tab to form a connection hole. This may allow for formula or other fluids to be prepared in advance and stored in a plurality of storage sub-chambers.

Once the infant bottle (100) is filled, it may be fully assembled by connecting the cutoff body (133) and connecting ring (103) to the main body (101), along with the nipple (107). The feeder (the person who is directly managing the feeding) would then bold the infant bottle (100) up to the infant in a relatively upright position, placing the nipple (107) at or near the infant's mouth. Next, the infant may latch onto the nipple (107), or the nipple (107) may otherwise be brought into contact with the infant's mouth. Then, the feeder may press the button (121) to initiate the flow of fluid from the main body (101) or other fluid holding system to the infant. In such an embodiment, the release of the button (121) will result in the movement of the pinch mechanism (131) away from the tube, (129), thereby removing the obstruction in the tube (129) created by the pinch mechanism (131). Once enough fluid has flowed, the feeder will release the button (121). The onboard electronic (125), or some other indicating system, may indicate to the user when to release the button (121). For example, a light ring (127) may illuminate when the bottle (100) is ready to indicate to the feeder to halt feeding. In some embodiments, the release of the pinch mechanism (131) and return to a closed state may be automated and controlled through the onboard electronics (125) such as, but not limited, through digital programming or an equivalent hardware circuit which will cause the pinch mechanism (131) to close off under certain conditions. These conditions are numerous but, in exemplary embodiments, may be after a set time period has elapsed, after a certain amount of fluid has passed, through the tube, upon detection of an outside signal from an external sensor (e.g. that could detect an infant taking a breath), or upon receipt from a remote system such as a remote computer or mobile device which can provide external control.

In theory, the closed state stops flow of the feeding fluid to allow the infant to swallow and breathe. The open state allows fluid to flow into the nipple (107) for the infant to feed. The stoppage of the fluid flow in the closed state of the pinch mechanism (105) may cue the infant to stop sucking and being swallowing and breathing. As the infant ceases sucking, the feeder may again allow the fluid to flow from the nipple (107).

As many infants will eventually pick up on the rhythm of feeding after 4 or 5 repetitions during any given feeding, when an infant begins to start pacing naturally, it can be beneficial to let the infant maintain this pace on their own without the assistance of the device. This will encourage correct feeding behavior. Since initiating feeding can be difficult, it would defeat the purpose to remove the bottle from the infant's mouth to remove the pinch mechanism (131) if the infant begins to self-pace. In an embodiment, the pinch mechanism (105) will be capable of being externally locked into the open state without disturbing a given feeding. In particular, the button (121) could be locked into the open state, which would typically mean that the button (121) is locked and held in the depressed position (in an embodiment that defaults to a closed state). In an embodiment, this locking can be provided by a switch placed anywhere on the infant bottle (101) that can be used to engage with the pinch mechanism (131) and prevent its movement. Generally, this may be accomplished by providing a connector ring (103) or cutoff body (133) specifically designed for this purpose as the switch would generally need to act through the main body (101), connector ring (103), cutoff body (133), and/or nipple (107).

Alternatively, there can be provided a frictional or rotational engagement in the pinch mechanism (131) or button (121). In an embodiment of such an arrangement, a ball bearing and slot arrangement could be provided where the infant bottle (100) has a particular rotation and orientation. In one orientation, the ball bearing is disengaged from the pinch mechanism (131) may move freely as discussed above. In an alternative arrangement, the infant bottle (100) itself may be rotated about its major axis, which rotation may cause the ball bearing to move and frictionally engage the pinch mechanism (131) serving to lock it into a particular position.

In a still further embodiment, a latch (not depicted in figures) can also be included to prevent the pinch mechanism (131) from moving, thus holding the infant bottle in an open or closed state. The latch could simply engage with the pinch mechanism (131), preventing further movement of the pinch mechanism (131). Any other means of preventing movement of the pinch mechanism (131) may be used, as would be understood by persons of ordinary skill in the art.

While the above has discussed a particular system for providing mechanical flow control of an infant feeding while using a pinch mechanism (131), there are also described herein additional alternative embodiments of a flow control system.

In a further embodiment, there is a provided a custom nipple (107) that is a generally a thicker nipple design, in which small tubes connect the nipple opening (117) to opening of the main body (101) and fluid supply. Such tubes may be similar to the tube (129) discussed above, but more numerous. The outer edge of the nipple (107) may follow a standard nipple shape as shown in FIG. 3 with the cylindrical teat extending from a wider base. In this nipple (107), the inner edge of the nipple (107) may be solid silicone, filling the entire inner region of the nipple (the volume of the nipple within the baby bottle). At the end of the teat, a nipple opening (117) may allow fluid flow through the tip of the teat to the infant's mouth. The base of the nipple (107) may contain a lip that has a larger diameter than the rest of the nipple (107), to prevent the nipple (107) from coming out of the collar of the infant bottle (100). From the base of the solid silicone nipple (107), begin 3-4 hollow cylindrical tubes. Each tube connects to the opening (117), allowing fluid from the infant bottle (100), through the openings in the base of the nipple (107) and into the infant's mouth. A chemically safe, silicone material may be used, similar to standard infant nipples.

There is then provided a generally cylindrically shaped connecting ring (103). The inner portion of the lower lip of the connecting ring (103) may be designed to screw onto a standard NICU baby bottle (to be the main body (101)). A switch or button (121) may be located on or near the outer portion of the connecting ring (103), easily accessible by a NICU nurse to change the state to one of the available positions for the switch or button (121). From above, the connecting ring (103) may have a donut shape, with an inner diameter that is wider than the nipple (107) base diameter, but smaller than the nipple (107) base lip. This allows the nipple (107) to pop into the connecting ring (103) securely.

In this embodiment, the nipple (107) and connecting ring (103) system is designed to allow a feeder to quickly and easily start and stop the flow of fluid to an infant immediately. By intermittently stopping the fluid flow, the infant will be cued to stop sucking, swallow the fluid and breathe, preventing aspiration and other complications. When the infant is ready to suck again the feeder can start the flow of fluid without the nipple (107) leaving the infant's mouth.

In a still further embodiment, there is a floating ball design, where the ball clogs the nipple (109) to prevent fluid flow. The nipple (107) in this design may have a standard outer shape shown as in FIG. 3. A standard thickness may be used for the silicone nipple (107). The lip of the base of the nipple (107) may secure the nipple (107) in place. A standard connecting ring (103) may screw on to an infant bottle (100) and hold the nipple (107) securely in place. A mesh metal cylindrical cage may be located in the center of the connecting ring (103), aligned with the flow of fluid from the infant bottle (100) to the nipple (107). The cage may acts as a track for an enclosed floating ball, preventing the ball from leaving the cage. The end of the cage closest, to the nipple opening (117) may be directly in contact with the inner surface of the nipple (107). The other end of the cage may be free within connecting ring (103).

On the outer edge of the connecting ring (103), or otherwise place on the infant bottle (100), a switch or button (121) can be set to 2, 3, or more positions. The switch may be designed to be easily maneuverable by the thumb of the user who is feeding the infant. For a 3-position embodiment the motions for the switch may be: on, off, and auto. In the on position, fluid may be allowed to flow through the infant bottle (100). In, this state, the switch may manually move the ring at the bottom of the cage away from the opening (117), preventing the ball from stopping fluid flow. In the off position, the switch may manually move the ring at the top of the track towards the opening (117), to force the ball to prevent fluid flow through the nipple (107). In the Auto position, neither ring is moved, which allows the ball to float. When the infant sucks, the ball moves with the flow of fluid and is sucked onto the ring near the opening (117). The ring stops the ball, and clogs the device, preventing flow. Once the infant stops sucking, the ball may once again float away from the ring and allow fluid to flow into the opening (117). Again, the switch may be a button (121).

This lift and clog design incorporates a ball and track system to halt formula flow. In this system a non-reactive mesh metal divider separates the nipple (107) from the rest of the infant bottle (100). The divider is located as far away from the nipple end as possible. The mesh allows formula to flow through the divider into the nipple opening (117). A plastic, air filled ball of about 1 cm diameter is trapped within the mesh nipple portion. The ball floats to the top of the liquid within the bottle (the bottom of the bottle when in the upside down drinking position). When the formula flow velocity is quick enough, the ball will be sucked into the nipple end and plug the flow of milk from reaching the infants mouth. Once the flow has stopped, the infant is cued to breathe and swallow. The formula stops flowing and the ball floats away allowing for future repetitions.

The cage may be only (3 or 4) skinny rods in a cylindrical shape, meant to keep the ball in a guided track. In some embodiments, the cage may have any design and may be constructed of any materials, as would be understood by persons of ordinary skill in the art. The cage's outer diameter would typically be barely smaller than the neck of the infant bottle (100) to allow easy insertion of the cage, yet large enough to prevent any leaks. By the neck of the infant bottle (100), there may be a ring of a smaller circumference than the ball. This ring may stop the ball, thus clogging the device. The ring may be solidly attached to the cage and base components. The ball must match the circumference of the inner cage and be larger than that of the ring. It will be understood that the buoyancy of the ball is key for the proper operation of the device.

In the event that the device becomes caught or stuck, thus inhibiting the function of the device or feeding in general, the option to reset the device would further advance the design. Infant formulas are designed to wieldy dissolve in water and to not have “lumps” as this can be dangerous in feeding. Thus, the infant bottle (100) is unlikely to jam (barring a failure of a portion of the device) as there is little for the device to jam on. Further, a jam resulting for damage to a component should result in the discontinued use of device being used currently to prevent any danger.

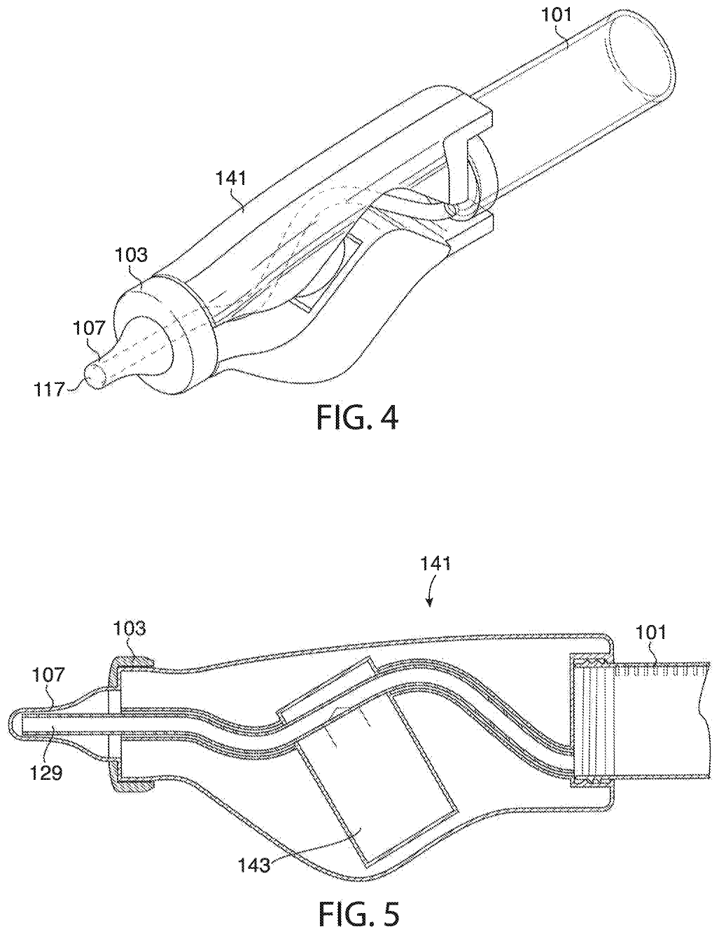

Other embodiments of an infant bottle (100) may include an automated cutoff body (141), which may have the appearance of that shown in FIGS. 4 and 5. Alternately, an embodiment of an infant bottle (100) including an automated a cutoff body (141) may have any appearance, such as the form shown in FIGS. 2 and 3. As shown in FIGS. 4 and 5, such an embodiment of an infant bottle (100) may have a cutoff body (141) that is connected to a main body (101) and separately to a nipple (107) via a connecting ring (103). The interior of the cutoff body (141) may include a tube (129) to convey fluids from the main body (101) or other fluid reservoir (such as a sub-chamber). The interior of the cutoff body (141) may also include an automated pinch value (143). In this embodiment, the automated pinch valve (143) may have any construction as long as it is capable of limiting the flow of fluids through the tube (129). In the embodiment depicted in FIG. 5, the automated pinch valve (143) may have a construction similar to the pinch mechanism shown in FIG. 3, but the automated pinch valve (143) will typically not be manually operated using a button (121). Instead, a control system (not depicted in the figures) Till typically control a motor (not depicted in the figures) or other means of moving the pinching components of the automated pinch valve (143).

Like the embodiment of an infant bottle (100) discussed above, the process of using the embodiment of an infant bottle (100) depicted in FIGS. 4 and 5 typically begins with filling the main body (101) or a sub-chamber with feeding fluid, such as milk. The feeder will then typically fully assemble the infant bottle (100) as shown in FIGS. 4 and 5. Next, the feeder will communicate the desired feeding amount or feeding rate to the infant bottle (100). For example, the infant bottle (100) may include an input system (such as a button, switch, or the like) and a control system (for controlling the pinch valve (143)).

The amount to be provided as set by the input system will generally be interpreted by the control system (such as but not limited to an appropriately programmed microprocessor) that may then serve to operate the pinch valve (143) to provide the desired amount of fluid, feeding duration, or other feeding aspect. The amount provided may be shown on a display (not depicted in the figures) that may also provide other valuable feeding information including, but not limited to, the total amount of fluid provided or the duration of this feeding event.

The control system will generally now modulate the position of the automated pinch valve (143) based on the desired feeding amount (or feeding rate). The activation and movement of the pinch valve (143) will generally be controlled by the control system, which may be a computer processor of standard type and appropriate software (instructions stored on a computer readable media) to provide the amount, or by corresponding mechanical means and structures. In the event that a fixed amount per feeding is provided, the control system will generally instruct a motor within or related to the pinch valve (143) to move the pinch valve structures away from the tube (129) to allow fluid to pass from the main body (101) to the nipple hole (117). The control system will then, at the appropriate time, move the pinch valve structures into a pinching contact with the tube (129) to prevent the flow of fluid from the main body (101) to the nipple hole (117).

During feeding, the infant will generally be sucking on the nipple (107). As should be apparent, the selected amount of fluid may be accessible from the nipple (107). The fluid, however, will not generally drip out of the nipple (107) in every embodiment (although it may depending on the size of opening (117)). Instead, the infant will suckle the nipple (107), compressing and sucking. The compression and sucking may serve to overcome surface tension of the fluid inside the forward portion of the tube (129) and expel the fluid forward and out of the hole (117) and into the infant's mouth. As should be apparent, once the selected amount of fluid has been expelled, the infant's attempts to get more fluid will not result in any more available. Instead, they will be sucking on what is essentially a pacifier. It is expected that the failure to obtain more fluid will trigger a swallow-breathe response from the infant to swallow that milk which is now in their mouth if they have not breathed before then. In some embodiments, a means for breaking vacuum seal created by the removal of fluid from the infant bottle (100) may be included. This may allow the fluid to flow though the tube (129) even where a vacuum may build up in the infant bottle (100) during feeding. Such a means may include, without limitation, a permanent or temporary opening in the area of the infant bottle (100) that holds the feeding fluid.

Upon a swallow-breathe response being detected from the infant (either manually by the user such as by a triggering button or through an automated detector), or upon completing the set duration or amount of fluid, the control system may again instruct the pinch valve (143) to enter an open state to allow further movement of the fluid through the tube (129). This pattern can then be repeated until the infant either loses interest in feeding, or all the fluid in the main body (101) has been expelled. As should be apparent from the above, the nipple (107) need not be removed from the infant's mouth until feeding is completed.

Upon completion of the feeding routine, the infant bottle (100) may be removed from the infant's mouth. The main body (101) may then generally be opened and the nipple (107), tube (129), and main body (101) (or any sub-chamber) may be separated. In every embodiment, the main body (101) may include graduated markings to indicate the amount of fluid remaining for record purposes and/or a display may be consulted to determine how much fluid the infant consumed. The nipple (107), tube (129), main body (101) my then be discarded or cleaned, as appropriate. The control system may store information related to the feeding in an on-board memory, or such information may be discarded after feeding is complete. Alternatively, the on-board memory may be downloaded into an associated computer program such as through the use of a base station that serves to both download information from the control system and may serve to recharge any onboard battery (not depicted in the figures) for controlling the onboard electronics and pinch valve (143).

The operation of the bottle (100) is similar if a feeding rate is used, but the control and presentation is somewhat different. If a rate is used, feeding will proceed as discussed above for the embodiment include a pinch valve (143). The control system may modulate the opening and the closing of the pinch valve (143) to provide fluid from the hole (117) at a set rate. For example, the pinch valve (143) may open and close 10 times at every sixty seconds, 5 times at every thirty seconds, or any other type of pattern. In this embodiment, as should be apparent, the amount of fluid available to the infant is still limited by the feed rate. Thus, an infant who takes in fluid faster than the selected rate will end up with at least a short window with no food available, which should trigger a swallow-breath response. Alternatively, an infant that is feeding too slow will generally not have much available fluid to potentially choke on as the amount available is always limited by the amount in provided, and this can be limited to an absolute maximum (akin to the limitation when a fixed amount is presented discussed previously).

The above discussion of various embodiments of an infant bottle (100) provides for embodiments of a self-contained generally handheld bottle (100) that may control how an infant feeds from the infant bottle (100). In these embodiments, the various components are typically designed to be located on or inside a main body (101) that generally resembles a traditional baby bottle. This type of arrangement is generally preferred as it can be a comforting design (particularly to a parent) and can provide for convenient and familiar way to feed the infant. It can also be easily handheld. However, it is by no means required and in other embodiments, the structures can be arranged differently.

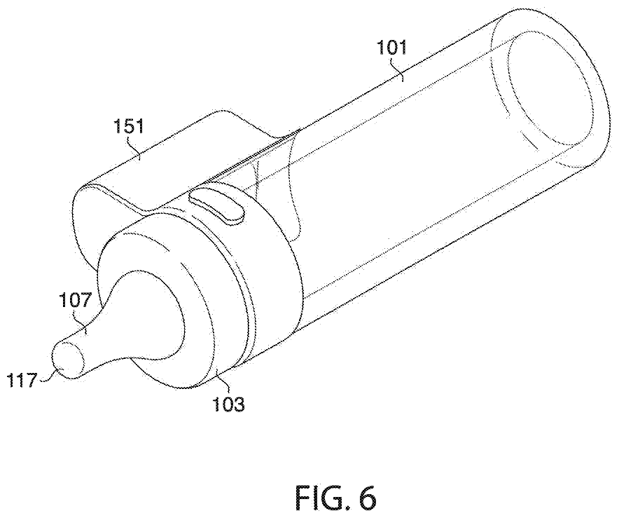

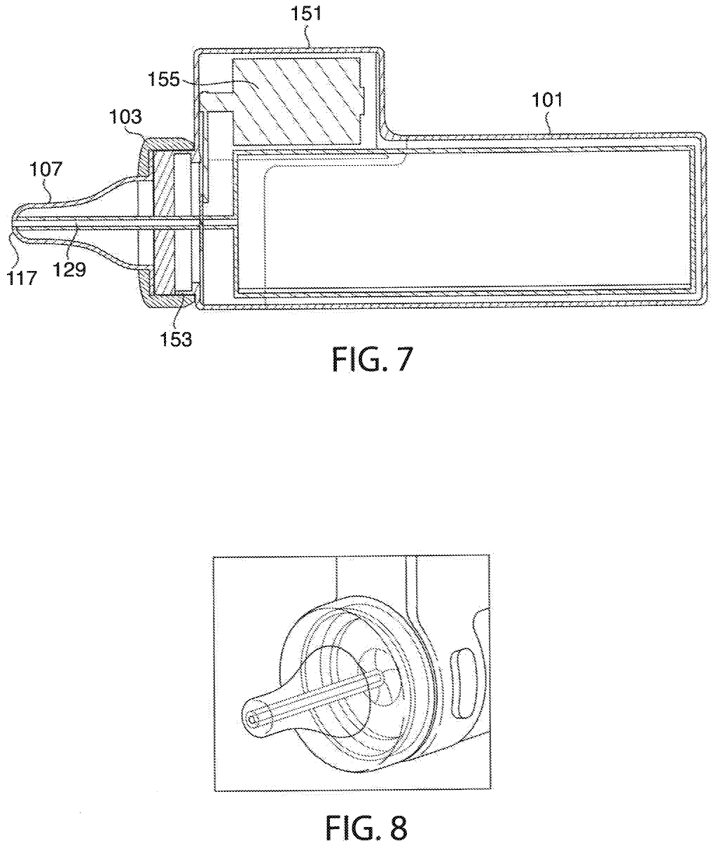

In another exemplary embodiments of an infant bottle (100) in accordance with this application is shown in FIGS. 6 and 7. This embodiment of an infant bottle (100) differs primarily in that the flow of fluid is not modulated using a pinching action, but rather by the modulation of an iris mechanism (153) As can be seen in FIG. 6, the overall external appearance of this embodiment of an infant bottle (100) is similar to the other embodiments discussed herein. Specifically, the infant bottle (100) includes a main body (101); a flow controlling structure (151) connected to the main body (101); and a nipple (107) connected to the flow controlling structure (151) via a connecting ring (103). However, the interior of the infant bottle (100) does not include a pinching mechanism and, instead, includes an iris mechanism (153).

The iris mechanism (153) may be housed within the flour controlling structure (151) along with a motor (155) that is designed to operate the iris mechanism (153). Also inside is a tube (129) for conveying fluid from the main body (101) to the hole (117) formed in the nipple (107). This tube (129) may be shorter in extent than the other tubes discussed herein because the flow controlling structure (151) may be relatively short. However, any tube (129) orientation and design may be used. This embodiment works much like the embodiment shown in FIGS. 4 and 5, at least in the sense that both feature similar automatic control regimes. The major difference is that the embodiment shown in FIGS. 6 and 7 may create a closed state by closing the iris mechanism (153), and may create an open state by opening the iris mechanism (153). Further, the rate of feeding may be controlled by controlling the diameter of the aperture created by the iris mechanism (153) when it is in an open state. The motor (155), along with a control system, may modulate the state of the iris mechanism (153). As would be understood by persons of ordinary skill in the art, the iris mechanism (153) may have any known construction and design that allows for the opening/closing and control of an aperture.

It should be apparent from the above that systems and methods are provided which allow for the feeding of infants that have not mastered the suck-swallow-breathe process generally considered to be standard for infant feeding. It is important to recognize that while the systems and methods discussed can serve to train an infant to perform the process through positive feedback when the process is performed correctly, the primary purpose of most of the embodiments is not training, but is to provide nutrition. In this way, the systems and methods serve to reduce or eliminate the need for an infant to remain hospitalized simply because they have not mastered the suck-swallow-breathe process or because their feeding needs to be monitored. Instead, the infant can be sent, home and a parent, even with little to no training, can successfully perform and monitor feeding.

Further, while the systems and methods discussed herein are particularly useful for premature infants that have not mastered the suck-swallow-breathe process, their use is by no means confined to them. Embodiments of the systems and methods can also be useful for infants, including full term infants, that have other medical issues that can complicate feeding or for infants where monitoring the amount of food intake is important. As the systems and methods are capable of monitoring and recording details of each feeding in a variety of ways, the systems and methods can be useful for feeding any kind of infant where monitoring of fluid uptake, rate of fluid uptake, and other feeding criteria are desired. An example of alternate applications would be for infants with gastroesophageal reflux, for whom slow, graded feedings can eliminate symptoms of reflux by providing time for gastric emptying prior to more fluid flowing from the nipple for the infant to then manage. It can also be used with infants who tend to consume bottles too quickly, increasing symptoms of discomfort and gas, by slowing down the feeding and allowing fluid to only flow at predetermined, specific intervals of time.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A baby bottle for controlling the flow of a feeding fluid, the bottle comprising:
a main body;
a tube in fluid communication with said main body and having a hollow volume and two opposing ends;
a nipple in fluid communication with said tube; and
a pinch mechanism including a plunger for obstructing flow of fluid through said tube;
wherein said pinch mechanism is configured to obstruct flow of fluid through said tube in a closed state; and
wherein said pinch mechanism is configured to not obstruct flow of fluid through said tube in an open state.

2. The bottle of claim 1, wherein said tube extends from the tip of the nipple to the main body.

3. The bottle of claim 1, wherein said main body is a rigid bottle.

4. The bottle of claim 1, wherein said infant is a preterm infant.

5. The bottle of claim 1, further comprising a feeding reservoir formed in said nipple, and wherein said tube extends from said feeding reservoir to said main body.

6. The bottle of claim 1, further comprising a control system for controlling said pinch mechanism and a motor, and wherein said control mechanism instructs said motor to alter the positioning of said plunger of said pinch mechanism.

7. The bottle of claim 6, wherein said tube extends from the tip of the nipple to the main body.

8. The bottle of claim 6, wherein said main body is a rigid bottle.

9. The bottle of claim 6, wherein said infant is a preterm infant.

10. The bottle of claim 6, further comprising a feeding reservoir formed in said nipple, and wherein said tube extends from said feeding reservoir to said main body.

11. A baby bottle for controlling the flow of a feeding fluid, the bottle comprising:
a main body;
a tube in fluid communication with said main body and having a hollow volume and two opposing ends;
a nipple in fluid communication with said tube; and
a cutoff mechanism positioned proximate to said tube;
wherein said cutoff mechanism is configured to obstruct flow of fluid through said tube in a closed state;
wherein said cutoff mechanism is configured to not obstruct flow of fluid through said tube in an open state; and
wherein said cutoff mechanism is biased toward said open state and will move to said closed state only upon action of a user of said baby bottle.

12. The bottle of claim 11, wherein said tube extends from the tip of the nipple to the main body.

13. The bottle of claim 11, wherein said main body is a rigid bottle.

14. The bottle of claim 11, wherein said infant is a preterm infant.

15. The bottle of claim 11, further comprising a feeding reservoir formed in said nipple, and wherein said tube extends from said feeding reservoir to said main body.

16. A baby bottle for controlling the flow of a feeding fluid, the bottle comprising:
a main body;
a tube in fluid communication with said main body and having a hollow volume and two opposing ends;
a nipple in fluid communication with said tube; and
a cutoff mechanism positioned proximate to said tube;
wherein said cutoff mechanism is configured to obstruct flow of fluid through said tube in a closed state;
wherein said cutoff mechanism is configured to not obstruct flow of fluid through said tube in an open state; and
wherein said cutoff mechanism is biased toward said closed state and will move to said open state only upon action of a user of said baby bottle.

17. The bottle of claim 16, wherein said tube extends from the tip of the nipple to the main body.

18. The bottle of claim 16, wherein said main body is a rigid bottle.

19. The bottle of claim 16, wherein said infant is a preterm infant.

20. The bottle of claim 16, further comprising a feeding reservoir formed in said nipple, and wherein said tube extends from said feeding reservoir to said main body.
